(19) United States
(12) Patent Application Publication
(10) Pub. No.: US 2020/0404006 A1
(43) Pub. Date: Dec. 24, 2020

(54) TELECOMMUNICATIONS DEFENCE SYSTEM

(71) Applicant: Samuel Geoffrey Pickles, Auckland (NZ)

(72) Inventor: Samuel Geoffrey Pickles, Auckland (NZ)

(21) Appl. No.: 16/752,319

(22) Filed: Jan. 24, 2020

Related U.S. Application Data
(63) Continuation of application No. 15/510,632, filed on Mar. 10, 2017, now abandoned.

(30) Foreign Application Priority Data
Sep. 12, 2014 (NZ) 631250

(51) Int. Cl. H04L 29/06; G06F 21/55

(52) U.S. Cl. CPC H04L 63/1416; H04L 63/1408; G06F 21/552; H04L 2463/146; H04L 63/0236; H04L 63/0428; H04L 63/0218

(57) ABSTRACT

A telecommunications defence system (TDS) comprises: at least one shield server; at least one target server communicating with the shield server and with a client telecommunications system (ClientTS), via a telecommunications network (TN). The target server is provided in a geographical location of the TN that is nearer the ClientTS than the shield server. The TDS further comprises an attack detection application (AttackDetectAPP), a communication application (CommAPP) and a shielding application (ShieldApp). The AttachDetectAPP, when executed on the target server, detects an attack aimed at the ClientTS via the TN and generates an attack source identification signal. The CommAPP transmits the identification signal to the shield server. The ShieldAPP, when executed on the shield server, causes the shield server to generate a shield signal in response to the transmitted identification signal, to provide at least one shield operative to shield the ClientTS from the attack.

### CROSS REFERENCE TO RELATED APPLICATIONS

This application is a continuation of U.S. patent application Ser. No. 15/510,632, filed Mar. 10, 2017, which is the U.S. National Stage of International Application No. PCT/NZ2015/050138, filed Sep. 10, 2015, which was published in English under PCT Article 21(2), which in turn claims priority to New Zealand Application No. 631250, filed Sep. 12, 2014, all of which are hereby incorporated by reference in their entirety.

### FIELD OF THE INVENTION

This invention relates to a telecommunications defence system and more particularly, the invention relates to an telecommunications defence system for shielding a client website and/or network from third party attacks.

### BACKGROUND

Most businesses and organisations operate a client telecommunications system, typically including a website, and usually at least a back end network which may be connected to the website. The website, and often the back end network, will be connected to a wider, external telecommunications network, such as the internet, to allow third parties to access the website, and sometimes selected parts of the business intranet or another network or networks to which the business is connected.

Such client website(s) and any connected client network(s) can, and should, be subject to a security protocol which attempts to control access to the website and any related network.

It is common for such a client telecommunications system to be subject to unwanted attacks whereby a third party attempts to access the website and any associated network without permission. Such third party attacks can be used to access/corrupt/download information held on the website and network. Whilst it may not be possible to stop such attacks being attempted, it is desirable to be able to stop such attacks from being successful.

Such attacks may originate from any part of a telecommunications network, including parts of the telecommunications network remote from the geographical location of the client telecommunications system. Thus an attack on a website in New Zealand may originate from USA for example. Existing systems typically defend against such attacks by providing a shield to the attack at the target destination. For example a shield server may sit just in front of the client website, in the geographical location of the client website. Providing a shield at such a late stage is not always desirable.

### OBJECT OF THE INVENTION

It is therefore an object of the invention to provide a telecommunications defence system which overcomes or at least ameliorates one or more disadvantages of the prior art, or alternatively to at least provide the public with a useful choice.

Further objects of the invention will become apparent from the following description.

### SUMMARY OF INVENTION

Accordingly in one aspect the invention may broadly be said to consist in a telecommunications defence system comprising:
at least one shield server;
at least one target server arranged, via the telecommunications network, to be in communication with the shield server and with a client telecommunications system, the target server being provided in a geographical location that is nearer the client telecommunications system than the shield server; and
an attack detection application, a communication application and a shielding application; wherein
the attack detection application contains instructions which, when executed on the target server, detects an attack aimed at the client telecommunications system via the telecommunications network and generates an identification signal indicative of the source of the attack;
the communication application containing instructions which, when executed on the target server, transmits the identification signal to the shield server;
the shielding application containing instructions which, when executed on the shield server, cause the shield server to generate a shield signal in response to the transmitted identification signal, to provide at least one shield operative to shield the client telecommunications system from the attack identified.

The above system therefore enables an attack to be detected at or near the geographical location of the client telecommunications system, but shielded at or near the source of the attack, or at least nearer the source of the attack than the client telecommunications system.

The above system therefore assists in reducing last resort shielding at or near the geographical location of the client telecommunications system. For example, for an attack originating in USA, a shield server may be located in USA and may be operative to shield the USA originating attack in USA, rather than, or in addition to, shielding at the destination location in New Zealand, where the client telecommunications system is located.

The identification signal is preferably indicative of the geographical source of the attack.

The identification signal may comprise the source IP address of the attack.

The target server is preferably located in the same geographical location as the client telecommunications system. In a most preferred example, the target server comprises part of the client telecommunications system and is located on the client's premises for example.

The attack detection application may comprise a decryption module operative on the target server to decrypt an encrypted attack.

A plurality of shield servers may be provided, at least one of which is located in a different geographical location from the target server. Preferably shield servers are located in a plurality of different geographical locations. More than one shield server may be located in each geographical location.

Preferably the identification signal is sent to more than one of the plurality of shield servers.

The identification signal may be sent to all of the shield servers in the system.

The, or another, shield application may also be adapted to be executed on the target server such that the target server generates or activates a shield.

The system may further comprise a distribution application containing instructions which, when executed on the target server, select whether the target server generates or activates a shield, or whether the shield server generates or activates a shield. The distribution application may be operative to determine the size of the attack, such that the shield server generates or activates the shield if the attack is above a predetermined size.

The system may further comprise a security database on which at least one client security signal is stored. The client security signalls) may comprise an electronic security certificate such as an SSL or TLS certificate for example. The client security signalls) may comprise an electronic private key, such as a cryptographic key for example. The client security signalls) may be used to allow secure access to a part of parts of the client telecommunications network.

The security database is preferably provided in, or at least in communication with, the target server. Preferably the security database is located in the same geographical location as the client telecommunications system. For example, if the client telecommunications system is located in New Zealand, the security database is also preferably located in New Zealand. This ensures that the client security signalls) need not be transmitted over the broader telecommunications network, and need not be transmitted outside of the geographical location of the client.

The system may be arranged to generate a pre-scan signal arranged to perform a pre-scan of the client telecommunications system so as to identify vulnerabilities of the client telecommunications system, the shielding application being arranged to generate a shield signal or signals in response to the vulnerabilities identified in the pre-scan.

The attack detection and/or communication applications may be stored on the target server, or on more than one target server, or stored in cloud storage in communication with the target server.

The or each shield application may be stored on the shield server, or on more than one shield server, or stored in cloud storage in communication with the shield server.

The or each shield application may comprise, or be operative to generate or activate, a shield or shields comprising a web application firewall (WAF).

According to a second aspect, the invention may broadly be said to consist in a target server or target server network of a telecommunications defence system, the at least one target server being arranged to be in communication with a shield server and with a client telecommunications system, via a telecommunications network, the target server being arranged to be provided in a geographical location of the telecommunications network that is nearer the client telecommunications system than the shield server;

the target server comprising an attack detection application containing instructions which, when executed on the target server, detects an attack aimed at the client telecommunications system via the telecommunications network and generates an identification signal indicative of the source of the attack;

the target server further comprising a communication application containing instructions which, when executed on the target server, transmits the identification signal to the shield server.

According to a third aspect, the invention may broadly be said to consist in a shield server or shield server network of a telecommunications defence system for shielding a client telecommunications system against a third party attack, the shield server comprising a shielding application containing instructions which, when executed on the shield server, cause the shield server to generate a shield signal in response to an identification signal indicative of the identity of the attack, to provide at least one shield operative to shield the client telecommunications system from the attack identified.

According to a fourth aspect, the invention may broadly be said to consist in a method of defending a client telecommunications system using a telecommunications defence system, comprising steps of:
a) providing at least one target server in communication with a shield server and with a client telecommunications system, via a telecommunications network;
b) locating the target server in a geographical location of the telecommunications network that is nearer the client telecommunications system than the shield server;
c) generating an attack identification signal indicative of the source of an attack aimed at the client telecommunications system via the telecommunications network;
d) generating and transmitting the identification signal to the shield server; and
e) generating a shield signal using the shield server in response to the transmitted identification signal, such that at least one shield is provided which is operative to shield the client telecommunications system from the attack identified.

According to a fifth aspect, the invention may broadly be said to consist in a telecommunications network comprising a telecommunications defence system comprising:
at least one shield server;
at least one target server arranged to be in communication with the shield server and with a client telecommunications system, via the telecommunications network, the target server being provided in a geographical location of the telecommunications network that is nearer the client telecommunications system than the shield server; the telecommunications defence system further comprising an attack detection application, a communication application and a shielding application; wherein:
the attack detection application contains instructions which, when executed on the target server, detects an attack aimed at the client telecommunications system via the telecommunications network and generates an identification signal indicative of the source of the attack;
the communication application contains instructions which, when executed on the target server, transmits the identification signal to the shield server; and
the shielding application contains instructions which, when executed on the shield server, cause the shield server to generate a shield signal in response to the transmitted identification signal, to provide at least one shield operative to shield the client telecommunications system from the attack identified.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a schematic of a telecommunications defence system in accordance with the invention, in communication with a telecommunications network;

FIG. 2 is a schematic of a target server of the telecommunications defence system of FIG. 1;

FIG. 3 is another schematic of part of the telecommunications defence system of FIG. 1; and

FIG. 4 is another schematic of the telecommunications defence system of FIGS. 1 to 3.

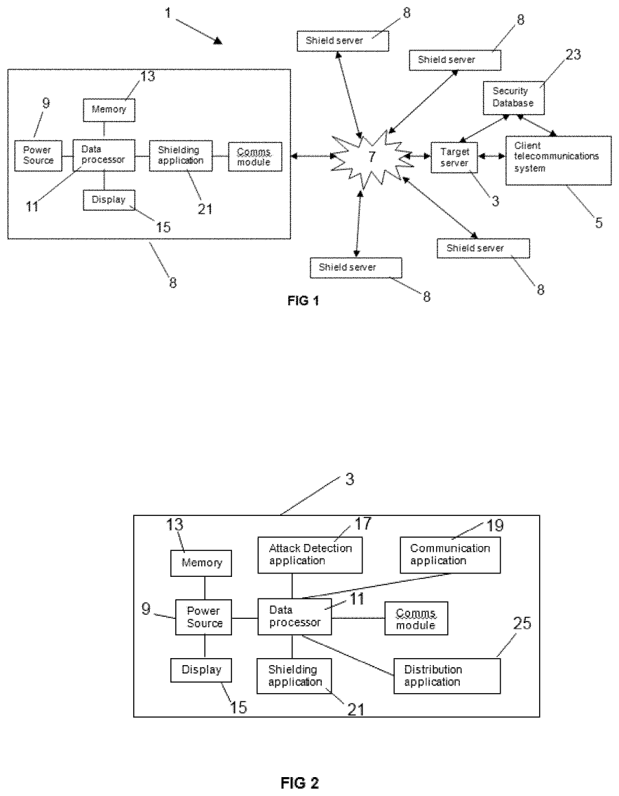

### DETAILED DESCRIPTION OF THE DRAWINGS

Throughout the description like reference numerals will be used to refer to like features in different embodiments.

Referring to the Figures, a telecommunications defence system 1 comprises at least one target server 3 adapted to be in communication with a client telecommunications system 5, and at least one shield server 8, via a telecommunications network 7. In this example, a plurality of shield servers 8 are provided, in a shield server network.

In this example a single target server 3 is provided although it is envisaged that multiple target servers 3 may be provided if required. The target server 3 comprises, or is connected to, a power source 9 which powers an electronic data processor 11, a memory 13 and, optionally, a display 15. Suitable control software applications and/or hardware applications are provided on the target server 3 as is known. The, or additional, control application(s) may additionally be stored externally of the target server 3, for example, in cloud storage, the target server 3 being in communication with such remote storage. The or each shield server 8 comprises similar components.

The client telecommunications system 5 may comprise a client website, or a more complex client telecommunications network which is connected to the telecommunications network 7.

The target server 3 is arranged, via the telecommunications network 7, to be in communication with the shield servers 8 and with the client telecommunications system 5, the target server 3 being provided in a geographical location that is nearer the client telecommunications system 5 than the shield servers 8.

The telecommunications system further comprises an attack detection application 17, a communication application 19 and a shielding application 21.

Applications 17, 19 may comprise software and/or hardware applications provided on the target server 3, or may comprise applications stored remotely, such as in cloud storage but accessible by the target server 3.

Application 21 may comprise a software and/or hardware application provided on the shield server 8, or may comprise an application stored remotely, such as in cloud storage but accessible by the shield server 8.

The attack detection application 17 contains instructions which, when executed on the target server 3, detects an attack aimed at the client telecommunications system 5 via the telecommunications network 7 and generates an identification signal indicative of the source of the attack.

The communication application 19 contains instructions which, when executed on the target server 3, transmits the identification signal to one or more of the shield servers 8.

The shielding application 21 contains instructions which, when executed on one or more of the shield server 8, cause the shield server(s) to generate a shield signal in response to the transmitted identification signal, to provide at least one shield operative to shield the client telecommunications system 5 from the attack identified.

The attack could comprise any vulnerability of the client website or network to external attack by a third party. Such a vulnerability may comprise one or more application vulnerabilities (such as SQL injection or Cross-site scripting) or infrastructure vulnerabilities (such as open ports or unpatched services). Such vulnerabilities may include any one or more of the following example vulnerabilities:
OWASP top ten web application vulnerabilities;
Injection;
Broken Authentication and Session state management;
Cross site scripting;
Insecure direct object references;
Security misconfiguration;
Sensitive data exposure;
Missing functional level access control;
Cross site request forgery;
Components with known vulnerabilities; and
Unvalidated redirects and forwards.

The invention therefore provides “cloud shielding” of the client website by providing a wide network of shield servers 8 globally. For example, there may be shield servers 8 in a number of different countries such as New Zealand, Australia and USA for example. One or more shield servers 8 may be provided in any desired geographical location, such as multiple countries for example.

The cloud-shielding provided by the system 1 defends against a third party attack at or near the source of the attack and not just at the destination, that is, not just at or near the geographical location of the client telecommunications system. A disadvantage of defence at destination is that all attack traffic is allowed into, for example, New Zealand (or where-ever the target website resides) and the attacks are stopped at the last second with shield servers sitting in front of the website. Instead, system 1 facilitates defending the client website at or near the source of the attack, that is, at the soonest possible opportunity.

To achieve this, the system 1 may include a “cloud signalling” protocol for the shield servers 8. Using such a protocol, shields can be created for a New Zealand client website and then those shields are distributed and published globally, via communication of the New Zealand shields from the target server 3 to one or more of the shield servers 8 located elsewhere.

A benefit of the system 1, is that the system 1 can store client security signals, such as SSL certificates and private keys, only within the same country as the vulnerable client website. This is useful for security-sensitive client organisations which may not want global propagation of private cryptographic keys for example. Thus a security database 23 may be provided on which such security signals are stored, the database 23 being part of, or in communication with, the client telecommunications system 5. The database 23 may be stored on memory of the target server 3 for example.

Attacks which are encrypted may initially be decrypted and detected by the target server 3, within the target country. The cloud signalling protocol can then share information on the attack with the other global nodes on a signalling bus, which distributes details of the attach, including location identification information such as the attacking IP address(es).

Advantageously, the point at which attack decryption, detection and cloud signalling occurs may be on the client's own premises.

Example System Architecture

Shield Cloud: In one example, with reference to FIG. 4, the system 1 described above, ie the shield cloud, is online all the time, for all normal users. Attacks are detected at the last-hop cloud node, that is, the target server 3, which is closest to the client application 5. This last-hop node hosts SSL private keys and certificates, stored in database 23, and is capable of detecting attacks which arrive via encrypted channels.

Signals are sent to the shield servers 8 identifying relevant attack metadata to allow other nodes, that is, shield servers 3 located elsewhere within the cloud, to mitigate these attacks closer to the source.

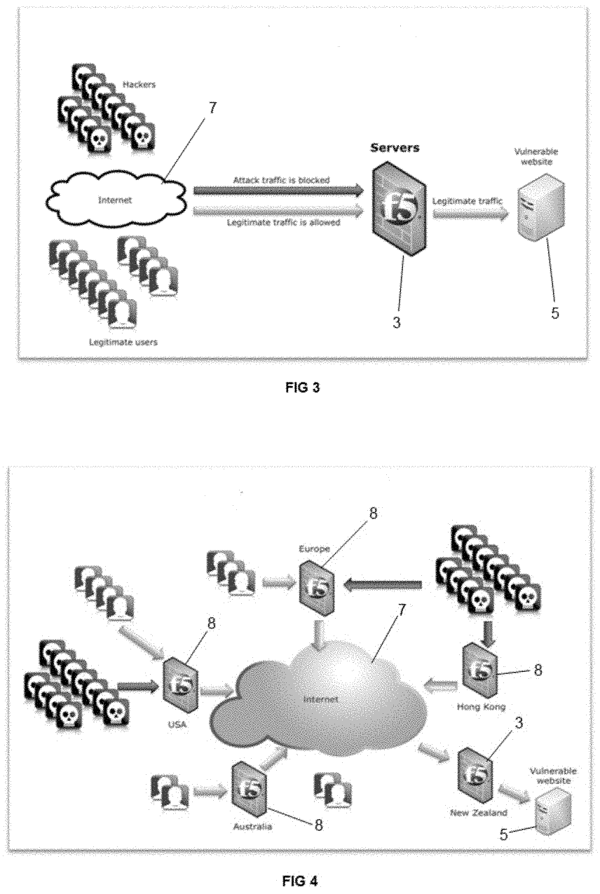

Shield On-Premise: In one example, the target server 3 of system 1 is installed as a shield detection node on the client's own site 5, consisting of, for example, an F5 Big IP device or virtual machine, or cluster of the same. Reference is made to FIG. 3 where the remote shield servers 3 are omitted.

This system hosts SSL private keys for any services which use SSL, and is capable of detecting attacks which arrive via encrypted channels.

Traffic is migrated onto the shield cloud, ie to one or more remote shield servers 8, when attacks are too large to handle within the customer datacenter. Target server 3 therefore comprises a distribution application 25 operative to control whether the attack is shielded by the target server 3 and whether the attack is additionally or alternatively shielded by one or more of the shield servers 8. In such cases, signals are sent to shield cloud control systems which identify relevant attack metadata to trigger the migration using DNS changes, and then allow other nodes within the cloud to mitigate these attacks closer to the source.

The system 1 may therefore comprise a global shield network which can identify and block attacks (including encrypted attacks) by IP address closer to the source of the attack, without requiring SSL certificates or other sensitive client security information to be hosted outside of the target country.

Details of Cloud Signalling Protocol:

Example integers of a cloud signally protocol used to control system 1 are set out below:

| Protocol Detail Item: | Description: |
|---|---|
| Transport | TCP/IP, using TLS/SSL and authentication |
| | for encryption and security |
| Signalling message | XML messages |
| structure | |
| Mitigation Mode | Activate Mitigation Mode 0 |
| Activation Signalling | Activate Mitigation Mode 1 |
| Messages | Activate Mitigation Mode 2 |
| | Activate Mitigation Mode x - custom |
| | The messages themselves are simple, |
| | however the activation of mitigation modes |
| | may involve complex behaviour such as DNS |
| | changes, which cause traffic to be moved |
| | onto the shield cloud and mitigation to |
| | commence. The exact behaviour of the shield |
| | cloud when each mode is activated is defined |
| | on a per-application basis, and stored |
| | centrally within a shield database. |
| | For example, mitigation strategies differ |
| | depending on whether the service type is |
| | Shield On-Premise or Shield Cloud, and |
| | which node within Shield Cloud is closest to |
| | the application server itself. |
| | Messages may contain: |
| | Device ID |
| | Application service ID |
| | Mode activation instruction |
| Attacking IP Notification | These messages contain details of one or |
| Messages | more IP addresses which are attacking the |
| | client application and which should be |
| | blocked by the shield cloud as close as |
| | possible to the source of the attack. |
| | Messages may contain: |
| | Device ID |
| | Application service ID |
| | Attacking IP address list |

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

1-32. (canceled)

33. A telecommunications defence system comprising:
at least one shield server;
at least one target server arranged to be in communication with the shield server and with a client telecommunications system, via a telecommunications network, the target server being provided in a geographical location of the telecommunications network that is nearer the client telecommunications system than the shield server; the telecommunications defence system further comprising an attack detection application, a communication application and a shielding application; wherein:
the attack detection application contains instructions which, when executed on the target server, detects an attack aimed at the client telecommunications system via the telecommunications network and generates an identification signal indicative of a source of the attack, wherein the target server is a separate server from the client telecommunications system;
the communication application contains instructions which, when executed on the target server, transmits the identification signal to the shield server; and
the shielding application contains instructions which, when executed on the shield server, cause the shield server to generate a shield signal in response to the transmitted identification signal, to provide at least one shield operative to shield the client telecommunications system from the attack identified.

34. The system of claim 33 operative such that an attack can be detected at or near the geographical location of the client telecommunications system, but shielded at or near the source of the attack, or at least nearer the source of the attack than the client telecommunications system.

35. The system of claim 33 wherein the identification signal is indicative of the geographical source of the attack.

36. The system of claim 33 wherein the identification signal comprises the source IP address of the attack.

37. The system of claim 33 wherein the target server is located in the same geographical location as the client telecommunications system.

38. The system of claim 37 wherein the target server comprises part of the client telecommunications system.

39. The system of claim 33 wherein the attack detection application comprises a decryption module operative on the target server to decrypt an encrypted attack.

40. The system of claim 33 wherein a plurality of shield servers are provided, at least one of which is located in a different geographical location from the target server.

41. The system of claim 40 wherein shield servers are located in a plurality of different geographical locations.

42. The system of claim 40 wherein more than one shield server is located in each geographical location.

43. The system of claim 40 wherein the identification signal is sent to more than one of the plurality of shield servers.

44. The system of claim 43 wherein the identification signal is sent to all of the shield servers in the system.

45. The system of claim 33 wherein the shield application is adapted to be executed on the target server such that the target server generates or activates a shield.

46. The system of claim 33 further comprising a distribution application containing instructions which, when executed on the target server, select whether the target server generates or activates a shield, or whether the shield server generates or activates a shield.

47. The system of claim 46 wherein the distribution application is operative to determine the size of the attack, such that the shield server generates or activates the shield if the attack is above a predetermined size.

48. The system of claim 33 further comprising a security database on which at least one client security signal is stored, the at least one client security signal being arranged to allow secure access to the client telecommunications network.

49. The system of claim 48 wherein the security database is provided in, or is at least in communication with, the target server.

50. The system of claim 48 wherein the security database is located in the same geographical location as the client telecommunications system.

51. The system of claim 48 operative such that the at least one client security signal is not transmitted over the telecommunications network.

52. The system of claim 51 operative such that the at least one client security signal is not transmitted outside of the geographical location of the client.

53. The system of claim 33 arranged to generate a pre-scan signal arranged to perform a pre-scan of the client telecommunications system so as to identify vulnerabilities of the client telecommunications system, the shielding application being arranged to generate a shield signal or signals in response to the vulnerabilities identified in the pre-scan.

54. The system of claim 33 wherein the attack detection and/or communication applications are stored on the target server, or on more than one target server, or stored in cloud storage in communication with the target server.

55. The system of claim 33 wherein the or each shield application is stored on the shield server, or on more than one shield server, or stored in cloud storage in communication with the shield server.

56. The system of claim 33 wherein the or each shield application comprises, or is operative to generate or activate, a shield comprising a web application firewall (WAF).

57. A target server of a telecommunications defence system, the target server being arranged to be in communication with a shield server and with a client telecommunications system, via a telecommunications network, the target server being arranged to be provided in a geographical location of the telecommunications network that is nearer the client telecommunications system than the shield server;
the target server comprising an attack detection application containing instructions which, when executed on the target server, detects an attack aimed at the client telecommunications system via the telecommunications network and generates an identification signal indicative of a source of the attack, wherein the target server is a separate server from the client telecommunications system; and
the target server further comprising a communication application containing instructions which, when executed on the target server, transmits the identification signal to the shield server.

58. The target server of claim 57, wherein the shield server comprises a shielding application containing instructions which, when executed on the shield server, cause the shield server to generate a shield signal in response to the identification signal indicative of the source of the attack, to provide at least one shield operative to shield the client telecommunications system from the attack.

59. A method of defending a client telecommunications system using a telecommunications defence system, comprising steps of:
a) providing at least one target server in communication with a shield server and with a client telecommunications system, via a telecommunications network;
b) locating the target server in a geographical location of the telecommunications network that is nearer the client telecommunications system than the shield server, wherein the target server is a separate server from the client telecommunications system;
c) generating, by the target server, an attack identification signal indicative of a source of an attack aimed at the client telecommunications system via the telecommunications network;
d) generating and transmitting, by the target server, the identification signal to the shield server; and
e) generating a shield signal using the shield server in response to the transmitted identification signal, such that at least one shield is provided which is operative to shield the client telecommunications system from the attack identified.

60. A telecommunications network comprising a telecommunications defence system comprising:
at least one shield server;
at least one target server arranged to be in communication with the shield server and with a client telecommunications system, via the telecommunications network, the target server being provided in a geographical location of the telecommunications network that is nearer the client telecommunications system than the shield server; the telecommunications defence system further comprising an attack detection application, a communication application and a shielding application; wherein:
the attack detection application contains instructions which, when executed on the target server, detects an attack aimed at the client telecommunications system via the telecommunications network and generates an identification signal indicative of a source of the attack, wherein the target server is a separate server from the client telecommunications system;
the communication application contains instructions which, when executed on the target server, transmits the identification signal to the shield server; and
the shielding application contains instructions which, when executed on the shield server, cause the shield server to generate a shield signal in response to the transmitted identification signal, to provide at least one shield operative to shield the client telecommunications system from the attack identified.
